(19) United States
(12) Patent Application Publication
(10) Pub. No.: US 2026/0279656 A1
(43) Pub. Date: Sep. 17, 2026

(54) COIL CONDUCTOR ATTACHMENT SYSTEM AND METHOD

(71) Applicant: HSP Hochspannungsgeräte GmbH, Troisdorf (DE)

(72) Inventors: Kamran Khan, Toronto (CA); Andrew Lang, Toronto (CA); Sean Alves, Ajax (CA)

(21) Appl. No.: 19/166,752

(22) PCT Filed: Mar. 22, 2023
(86) PCT No.: PCT/US2023/015887

§ 371 Date: Sep. 18, 2025

(51) Int. Cl. H01F 27/29; H01F 41/10

(52) U.S. Cl. CPC H01F 27/29; H01F 41/10

(57) ABSTRACT

A coil conductor attachment system includes a termination bar, a coil end receiver barrel extending therefrom, a connector attaching the barrel to the bar, a conductor having a conductor end portion at least partially disposed within the barrel, and a crimped portion of the coil end receiver barrel forming a mechanical and electrical connection with the conductor end portion disposed therein. In another aspect, a method of terminating a coil winding includes providing a termination bar, attaching a coil end receiver barrel to the termination bar, disposing a coil conductor end portion at least partially within the barrel, and crimping a portion of the coil end receiver barrel to form a mechanical and electrical connection with the coil conductor end portion.

### CROSS-REFERENCE TO RELATED APPLICATIONS

### Background

Aspects of the present invention generally relate to electrical coils, such as dry type air core reactors, of the type used in utility and power applications, and more specifically relates to conductor connections of such coils.

### Brief Summary

In one aspect, a coil conductor attachment system includes a termination bar having a coil conductor receiving opening disposed therethrough from a first side to a second side, a coil end receiver barrel disposed in the opening and extending therefrom, a connector attaching the barrel to the termination bar, a conductor having a conductor end portion at least partially disposed within the barrel, and a crimped portion of the coil end receiver barrel disposed outside of the opening forming a mechanical and electrical connection with the conductor end portion disposed therein.

In another aspect, a coil conductor attachment system includes a termination bar, a coil end receiver barrel extending therefrom, a connector attaching the barrel to the bar, a conductor having a conductor end portion at least partially disposed within the barrel, and a crimped portion of the coil end receiver barrel forming a mechanical and electrical connection with the conductor end portion disposed therein.

In another aspect, a method of terminating a coil winding includes providing a termination bar, attaching a coil end receiver barrel to the termination bar, disposing a coil conductor end portion at least partially within the barrel, and crimping a portion of the coil end receiver barrel to form a mechanical and electrical connection with the coil conductor end portion.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a view of an electrical apparatus, such as a dry-type air core reactor, that can benefit from disclosed structural arrangements for attaching conductor winding packages in the air core reactor.

FIG. 2A illustrates a coil conductor attachment system in accordance with one embodiment.

FIG. 2B illustrates a coil conductor attachment system in accordance with one embodiment.

FIG. 2C illustrates a coil conductor attachment system in accordance with one embodiment.

FIG. 2D illustrates a coil conductor attachment system in accordance with one embodiment.

FIG. 3 illustrates a method 300 in accordance with one embodiment.

### DETAILED DESCRIPTION

In the following detailed description, various specific details are set forth in order to provide a thorough understanding of such embodiments. However, those skilled in the art will understand that disclosed embodiments may be practiced without these specific details that the aspects of the present invention are not limited to the disclosed embodiments, and that aspects of the present invention may be practiced in a variety of alternative embodiments. In other instances, methods, procedures, and components, which would be well-understood by one skilled in the art have not been described in detail to avoid unnecessary and burdensome explanation.

Furthermore, various operations may be described as multiple discrete steps performed in a manner that is helpful for understanding embodiments of the present invention. However, the order of description should not be construed as to imply that these operations need be performed in the order they are presented, nor that they are even order dependent, unless otherwise indicated. Moreover, repeated usage of the phrase “in one embodiment” does not necessarily refer to the same embodiment, although it may.

It is noted that disclosed embodiments need not be construed as mutually exclusive embodiments, since aspects of such disclosed embodiments may be appropriately combined by one skilled in the art depending on the needs of a given application.

The terms air core reactor, air core inductor, and air core coil are often used interchangeably by those skilled in the art and refer to inductors that involve an air core in lieu of a magnetic core made of a ferromagnetic material. An inductor (reactor, or coil) is a passive electrical component that may be used to store energy available in an electromagnetic field when electric current flows through the inductor. Electrical coils, such as dry type air core reactors of the type used in utility and power applications, typically comprise one or more conductor winding packages positioned to extend along a central axis from a first reactor end to a second reactor end that is opposite the first reactor end. Winding packages are typically formed by applying an insulator, such as an uncured epoxy resin, to conductors and then winding the conductors to build a cylindrical winding package. The ends of the conductors are then connected to a termination bar, such as a spider arm.

Electrically and mechanically joining the conductors to the termination bar is done with either of two fundamental methods. In one method the conductor terminations are performed during the winding process via an intermediate member. Welding during the winding process has several disadvantages. The primary concern is the possibility of potentially allowing contaminates to become imbedded in uncured windings. Such contamination (e.g., particles of aluminum released during weld preparation or weld cleaning, weld splatter or weld carbon) can compromise the electrical function of the winding and cause premature failure. The contamination risk is compounded as two welds are required at each end of the intermediate member, one at the termination bar and one at the winding termination. Additionally, the weld between the intermediate member and the winding termination also requires the insulation be reapplied to protect the adjacent winding turn. A further pragmatic complication is that this method may interrupt the winding production efficiencies as the “winders” have to stop to allow welders to fuse metal at every termination.

An alternative method can be employed whereby the termination bar welds may be performed after the curing of the winding directly to the conductor. The disadvantages of this process include cleaning of hardened resin coated wires which increases process times for weld preparation and possibly disturbs the sealing of the conductor against moisture penetration. The conductor is stiffer and harder to manipulate due to the cured resin. The removal of the cable isolation is made harder by the cured resin on the conductor. Cured resin between wires of the conductor is unavoidably stressed. Furthermore, the welder must fuse the metal without damaging installed neighboring components, many of which are composite and cannot be repaired. The prep and cleaning of the weld on the cured coil has a risk of contamination if not cleaned (note that the particles should not stick as the coil is fully cured).

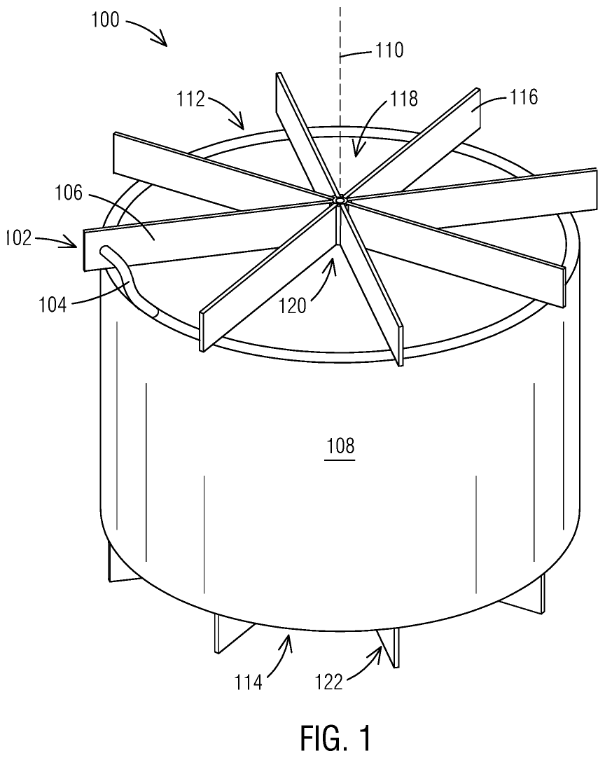

The present disclosure recognizes that these conventional processes may by improved by attaching, such as by welding, a crimp barrel to the termination bar before coupling conductors 104 to the termination bar (as presented in FIG. 1). Advantageously, welding occurs before the winding process so that there is reduced contamination risk to the uncured winding from weld preparation as there is in the present process. A crimping process is within the skill-set of coil winders and thereby negates the needs for welders at the winding process.

FIG. 1 is a view of an electrical apparatus, such as an air core reactor 100, that can benefit from disclosed embodiments described in greater detail below. Air core reactor 100 includes one or more electrical devices, such as a plurality of radially-concentric, spaced-apart cylindrical winding packages 108 positioned about a central axis 110 that extends from a first reactor end 112 to a second reactor end 114. The cylindrical winding packages 108 may define a centrally-disposed hollow cavity 118. It will be appreciated that air core reactor 100 designs may include fewer or substantially more winding packages than shown in FIG. 1. For simplicity of illustration, FIG. 1 illustrates just one winding package labelled 108.

Cylindrical winding packages 108 may be positioned between an upper spider unit 120 and a lower spider unit 122, which, in certain embodiments, may function as terminals or termination bars for connecting power lines and/or for interconnecting the cylindrical windings in a desired electrical configuration, such as a parallel circuit arrangement. It will be appreciated that the winding packages of the reactor are rigidly held between upper spider unit 120 and lower spider unit 122 by appropriate means, such as, without limitation, non-conductive materials, which may include precured composite members or uncured composite members (that are hardened when the reactor is cured). The spider units 120, 122 may constitute structural members that facilitate lifting and/or fastening to the mounting system of a given reactor to other reactors, or both, or to a reactor foundation. A standoff insulator may be attached to spider ends 116 and they may support current-carrying conductor bar 106. Cylindrical winding package 108 may be radially separated from one another by a plurality of circumferentially spaced-apart “duct sticks” or spacers, which may be positioned to have a vertical orientation extending in a direction parallel to central axis 110.

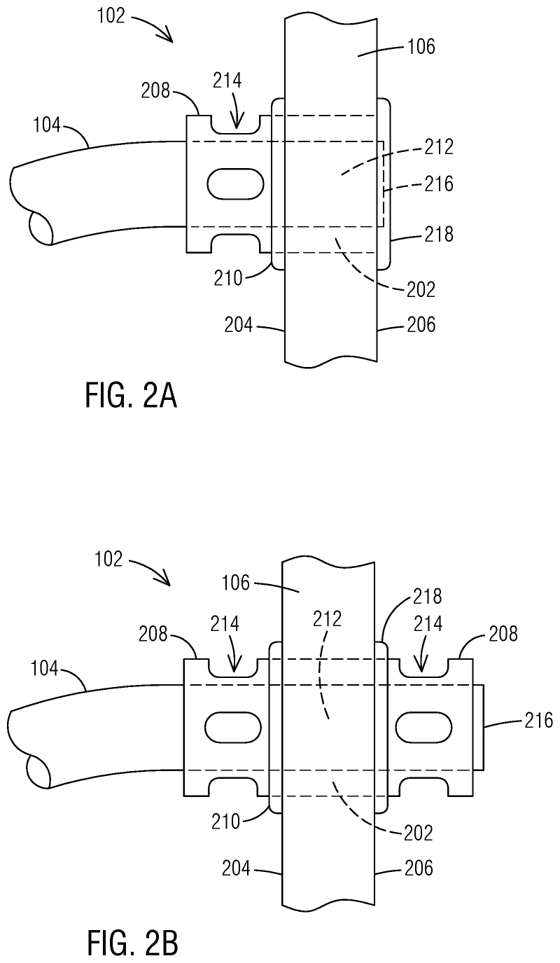

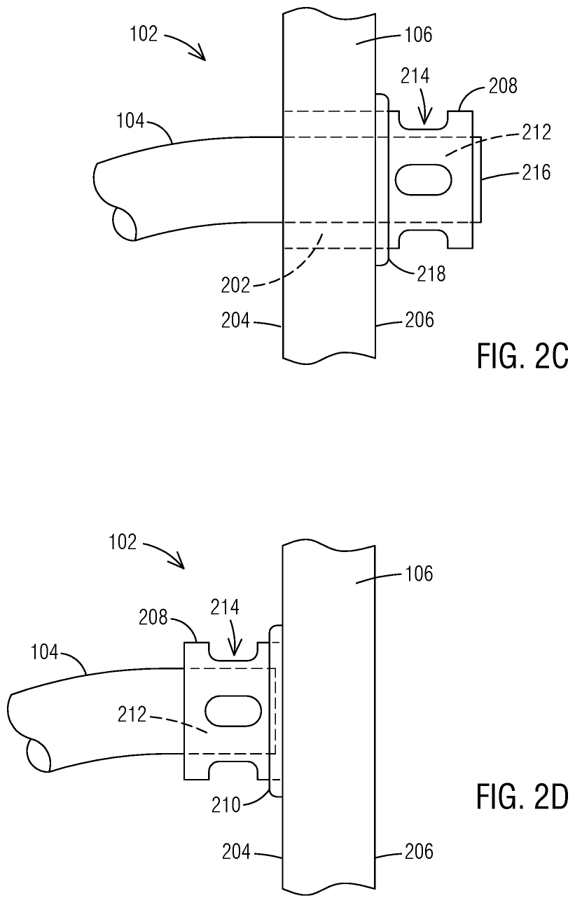

In the embodiment shown in FIG. 1, the air core reactor 100 includes a first cylindrical winding package 108 positioned to extend along a central axis 110 from a first reactor end 112 to a second reactor end 114. A second cylindrical winding package is positioned radially inward of the first cylindrical winding package 108 and positioned to extend along the central axis 110 from the first reactor end 112 to the second reactor end 114. A conductor bar 106 extends in a direction away from the central axis 110 to a spider end 102 and is coupled to the first cylindrical winding package 108 and the second cylindrical winding package 108. Although in FIG. 1 the arms of spider units 120, 122 are illustrated as extending from central axis 110, it will be appreciated that in certain embodiments, the spider arms 116 may be truncated. That is, the spider arms 116 need not extend from central axis 110 but from a point located between central axis 110 and spider end 116. A conductor 104 of the winding package 108 may be attached to the termination bar 106 in a coil conductor attachment system 102 as more fully depicted in FIG. 2A-2D.

In the exemplary embodiments shown in FIGS. 2A-2D, a coil conductor attachment system 102 includes a conductor 104 having a coil conductor receiving opening 202 disposed therethrough, for example, extending from a first side 204 to a second side 206 of the termination bar 106. A coil end receiver barrel 208 is disposed in the opening 202. In one aspect, the barrel 208 may be sized to form an interference fit within the opening 202. In yet another aspect, the barrel 208 is disposed to extend from a side of the termination bar 106, such as the first side shown in FIG. 2A, the second side 206 shown in FIG. 2C, or both sides as shown in FIG. 2B. The system 102 further includes a connector 210 attaching the barrel 208 to the termination bar 106, such as partially around a perimeter of the barrel 208, connecting it to the first side 204 of the termination bar 106. The connector 210 may include a first weld or a collar. The system 102 further includes a conductor 104 having a conductor end portion 212 at least partially disposed within the barrel 208. The system 102 further includes a crimped portion 214 of the coil end receiver barrel 208 disposed outside of the opening 202, forming a mechanical and electrical connection with the conductor end portion 212 disposed therein. In an aspect, the barrel 208 is formed from a metallic material that may be crimped using conventional crimping tools. A covering 218, such as a second weld, may be provided to cover the exposed conductor end 216. In another embodiment shown in FIG. 2D, the coil conductor attachment system 102 includes a termination bar 106 having a coil end receiver barrel 208 extending therefrom and a connector attaching the barrel to the termination bar 106, such as at the first side 204. The system 102 also includes a conductor 104 having a conductor end portion 212 at least partially disposed within the barrel 208. The barrel 208 further includes a crimped portion 214 forming a mechanical and electrical connection with the conductor end portion 212 disposed therein.

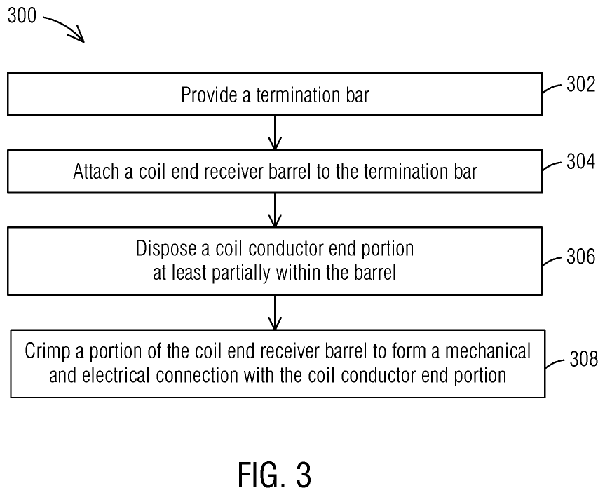

FIG. 3 depicts a flowchart for a method of terminating a coil winding according to an embodiment. In block 302, method 300 includes providing a termination bar 106. In block 304, method 300 includes attaching a coil end receiver barrel 208 to the termination bar 106. In an embodiment, attaching further includes welding the barrel 208 to a side of the termination bar 106. In block 306, method 300 includes disposing a coil conductor end portion 212 at least partially within the barrel 208. In block 308, method 300 includes crimping a portion of the coil end receiver barrel 208 to form a mechanical and electrical connection with the coil conductor end portion 212. In an embodiment, the termination bar 106 further includes a coil conductor receiving opening 202 extending therethrough, the method 300 further including disposing the coil end receiver barrel 208 within the receiving opening 202 so as to extend therefrom.

The method 300 may further include removing cable isolation from the end portion 212. The method 300 may further include disposing heat shrink tubing around the end portion 212 before disposing the end portion 212 in the barrel 208. The method 300 may also include welding the conductor end 216.

Although an exemplary embodiment of the present disclosure has been described in detail, those skilled in the art will understand that various changes, substitutions, variations, and improvements disclosed herein may be made without departing from the spirit and scope of the disclosure in its broadest form.

### LISTING OF DRAWING ELEMENTS

100 air core reactor
102 system
104 conductor
106 termination bar
108 first and second cylindrical winding package
110 central axis
112 first reactor end
114 second reactor end
116 spider end
118 hollow cavity
120 upper spider unit
122 lower spider unit
202 opening
204 first side
206 second side
208 barrel
210 connector
212 end portion
214 crimped portion
216 conductor end
218 covering
300 method
304 block
306 block
308 block

1. A coil conductor attachment system comprising:
a termination bar having a coil conductor receiving opening disposed therethrough from a first side to a second side;
a coil end receiver barrel disposed in the opening and extending therefrom,
a connector attaching the barrel to the termination bar;
a conductor having a conductor end portion at least partially disposed within the barrel; and
a crimped portion of the coil end receiver barrel disposed outside of the opening forming a mechanical and electrical connection with the conductor end portion disposed therein.

2. The coil conductor attachment system of claim 1, wherein the barrel extends from a first side of the termination bar.

3. The coil conductor attachment system of claim 2, wherein the barrel extends from a second side of the termination bar.

4. The coil conductor attachment system of claim 1, wherein the barrel extends from a first side and a second side of the termination bar.

5. The coil conductor attachment system of claim 1, where the connecter comprises a first weld or a collar.

6. The coil conductor attachment system of claim 1, wherein the connector forms a mechanical and electrical connection between the termination bar and the barrel.

7. The coil conductor attachment system of claim 1, wherein the barrel is configured to form an interference fit within the opening.

8. The coil conductor attachment system of claim 1, further comprising a covering at a conductor end.

9. A coil conductor attachment system comprising:
a termination bar;
a coil end receiver barrel extending therefrom;
a connector attaching the barrel to the bar;
a conductor having a conductor end portion at least partially disposed within the barrel; and
a crimped portion of the coil end receiver barrel forming a mechanical and electrical connection with the conductor end portion disposed therein.

10. A method of terminating a coil winding comprising:
providing a termination bar;
attaching a coil end receiver barrel to the termination bar;
disposing a coil conductor end portion at least partially within the barrel; and
crimping a portion of the coil end receiver barrel to form a mechanical and electrical connection with the coil conductor end portion.

11. The method of claim 10, wherein the termination bar further comprises a coil conductor receiving opening extending therethrough.

12. The method of claim 11, further comprising disposing the coil end receiver barrel within the receiving opening to extend therefrom.

13. The method of claim 10, wherein attaching further comprises welding the barrel to a side of the termination bar.

14. The method of claim 10, further comprising removing cable isolation from the end portion.

15. The method of claim 10, further comprising disposing heat shrink tubing around the end portion before disposing the end portion in the barrel.

16. The method of claim 10, further comprising welding a conductor end.
